(19) United States
(12) Patent Application Publication
(10) Pub. No.: US 2022/0309747 A1
(43) Pub. Date: Sep. 29, 2022

(54) COMMUNICATION SYSTEM AND METHOD

(71) Applicant: Surrey Satellite Technology Limited, Guildford, Surrey (GB)

(72) Inventor: Liam Sills, Guildford, Surrey (GB)

(73) Assignee: Surrey Satellite Technology Limited, Guildford, Surrey (GB)

(21) Appl. No.: 17/615,635

(22) PCT Filed: Jun. 3, 2020
(86) PCT No.: PCT/GB2020/051338

§ 371 Date: Dec. 1, 2021

(30) Foreign Application Priority Data
Jun. 3, 2019 (GB) 1907867.4

(51) Int. Cl. G06T 17/05; H04B 10/2575

(52) U.S. Cl. CPC G06T 17/05; H04B 10/2575

(57) ABSTRACT

A communications system in which a first end-point obtains spatial data defining a first subset of spatial features at a first geographic location, and a second end-point provides spatial data defining a model of a second subset of spatial features at the first geographic location. A controller selects model data and interaction data corresponding to the second subset of spatial features, and identifies, based on the selected model data and the interaction data, a third subset of spatial features represented in the second subset of spatial features and the first subset of spatial features. Real-time data defining the third subset of spatial features is communicated to the second end-point via a low-latency communications link. The second endpoint obtains additional data via a high latency communications link.

### TECHNICAL FIELD

The present disclosure relates to methods and apparatus, and more particularly to systems for communication in which data describing a remote environment is transmitted to a communications end-point to enable a model of the remote environment to be provided at the end-point, still more particularly the disclosure relates to telepresence.

### BACKGROUND

Telepresence or tele-existence experiences were described by Marvin Minsky in Omni Magazine in June 1980 (http://www.housevampyr.com/training/library/books/omni/OMNI_1980_06.pdf, page 40) and by Sasumu Tachi in the same year. Their proposal required large volumes of 3D visual, audio and haptic data to be transmitted between disparate locations on the Earth, and beyond, with very low latency. Telepresence today may refer to a set of technologies which allow a person to feel as if they were present at a place other than their true location. Some telepresence systems may enable their operators to interact with the environment at that other remote location via an input output interface at that location. Such an interface may comprise data gathering capability and may be arranged to provide output signals such as control signals for controlling actuators for example tele-operated robots and electromechanical actuators.

Telepresence may provide that the users' senses, not just vision and hearing, be provided with such stimuli as to give the feeling of being present in that other location. Additionally, users may be given the ability to affect the remote location. In this case, the user's position, movements, actions, voice, etc. may be sensed, transmitted and duplicated in the remote location to bring about this effect. Therefore information may be traveling in both directions between the user and the remote location.

A popular application is found in telepresence videoconferencing, the highest possible level of video telephony. Telepresence via video deploys greater technical sophistication and improved fidelity of both sight and sound than in traditional videoconferencing. Rather than traveling great distances in order to have a face-face meeting, it is now commonplace to instead use a telepresence system, which uses a multiple codec video system (which is what the word “telepresence” most currently represents).

Such systems are however inherently limited—they typically offer a 2D picture of a remote 3D environment, and a user's opportunity to interact with that environment is very limited. Typically, the camera involved is static, and it generally only provides a 2D video stream of the remote environment. Typically therefore, such systems can only provide a view of a remote location from one of a small number of pre-defined locations—e.g. the locations at which static video conferencing cameras are located.

A variety of different data models of the earth have been proposed. Computerised mapping software is commonplace. Typically this comprises a digital map of the earth's surface indicating geographic features at each of the locations described by the map such as the height above or below sea level of the earth's surface and other topographic features, the presence of rivers or oceans, geology etc. In addition to mapping in the sense of cartography, three dimensional maps of some spaces, both real and imagined, also exist. These may comprise digital data describing the surfaces and other spatial features which exist in an environment. Such data may be derived from a variety of sources. Google Earth is a computer program that renders a 3D representation of Earth based on satellite imagery. The program maps the Earth by superimposing satellite images, aerial photography, and GIS data onto a 3D globe, allowing users to see cities and landscapes from various angles. Users can explore the globe by entering addresses and coordinates, or by using a keyboard or mouse. Google Earth is also able to show various kinds of images overlaid on the surface of the earth and is also a Web Map Service client. Other features allow users to view photos associated with a given geographic location, the so-called “street view” facility being the most sophisticated example of this. It may also provide a user with access to other auxiliary information such as a Wikipedia entry about a location. It can thus be seen that a variety of communications protocols, and a variety of communications channels, may be used to provide information to a communications end-point which describes the world at a continuum of locations remote from that end-point.

Whilst such information may be useful for navigation and reference purposes, it is not updated with sufficient regularity to provide a “real-time” experience. The quantity of data required to provide a detailed 3D model of the entire globe, and the objects in it, is very significant indeed. This is further complicated by the fact that those objects move. There is therefore no simple way to provide users with a true telepresence experience, and so called “virtual reality” users must content themselves with simulated, or imaginary, environments.

The present disclosure aims to address the above described technical problems, and related technical problems.

### SUMMARY

Aspects and examples of the present disclosure are set out in the appended claims.

An aspect of the disclosure provides a communications system which obtains a 3D spatial model of the features in the vicinity of a first end point in a network, and provides that 3D spatial model to a second endpoint. The features in the data which is obtained may represent only a subset of a larger, perhaps global, model. For example this first subset may represent only the features within the field of view of the first end point. The system then identifies a second subset of features of that larger model, which may represent the features within an interaction range of the view point, in the digital model of the first geographic location, which is presented at the second endpoint.

The system can then use interaction data to identify a third subset of spatial features (amongst those in the field of view of the first end point, and within interaction range of the view point presented to the operator at the second end point), to select data which is to be sent from the first end point to the second end point via a low latency communication link.

The low latency communication link may comprise (a) an optical link between a relay station (e.g. on a high altitude platform HAP) and a satellite such as in LEO; and (b) an RF link between each of the end points and the relay station, e.g. on a HAP. Features which the interaction data indicates are not to be subject to interaction (e.g. having an interaction probability less than a selected threshold level) may be sent via a higher latency communication link, such as a ground based telecommunications network.

The interaction data may indicate a likelihood that an operator at the second end point will perform a virtual interaction with the model of the spatial features at the first geographic location. This interaction data may be obtained from user input (e.g. a user may identify objects in a virtual environment with which he/she wishes to interact), or it may be derived from historical data of past interactions, or from some other statistical or predictive model.

Accordingly, there is described herein a communications system comprising: a data store storing a data model comprising:
(i) model data defining a model of an environment comprising a plurality of spatial features; and (ii) interaction data indicating a likelihood of interaction of each of the plurality of spatial features;
a communication interface operable to communicate with:
(a) a first end-point comprising a data gathering interface for obtaining spatial data defining a first subset of spatial features at a first geographic location; and
(b) a second end-point disposed at a second geographic location the second end-point comprising an operator interface adapted to provide, via the operator interface, spatial data defining a model of a second subset of spatial features at the first geographic location;
a controller, in communication with the data store and with the end-points, and configured to:
   select, from the data model, model data and interaction data corresponding to the second subset of spatial features,
   identify, based on the selected model data and the interaction data, a third subset of spatial features represented in the second subset of spatial features and the first subset of spatial features;
   operate the first end-point to gather real-time data defining the third subset of spatial features, and to communicate the real-time data to the second end-point via a low-latency communications link;
   operate the second end-point to provide, via the operator interface and based on the real-time data and on additional data, spatial data defining the model of the second subset of spatial features,
   wherein the additional data comprises at least one of the model data and the first subset of spatial features, wherein the second endpoint obtains the additional data via a high latency communications link.

The interaction data may indicate a likelihood of movement of said spatial features. The controller may be configured to identify, in the model data, spatial features adjacent to the second subset of spatial features and to send the identified adjacent features to the second end-point via the high latency communications link. The controller may be configured to predict an operation of the second end-point. For example it may predict a movement of the view point or field of view based on previous movement and/or speed. It may thus identify the adjacent features based on such predictions.

The controller may be configured to establish a communication session between the first end-point and the second end-point by sending, to the second end-point, the model data and the interaction data corresponding to the first subset of spatial features. The model data and the interaction data corresponding to the first subset of spatial features may be sent via the high latency communication link.

The low-latency link may comprise a relay station (which may include an aircraft carried radio frequency (RF) telecommunications apparatus for communication with one of the first end-point and the second end-point. The aircraft may comprise a HAP. The low latency communication link may further comprise an optical communication link between a satellite and the relay station (e.g. the aircraft carried RF telecommunications apparatus). The relay station may comprise RF telecommunications apparatus, for communicating via an RF link. It may also comprise an optical communications interface for communicating via an optical communications link such s any of the optical links described or claimed herein. The relay stations may also comprise modulation and/or demodulation circuitry for taking signals received via one interface (e.g. the RF interface), and relaying them on via the other interface (e.g. the optical interface) and vice versa.

An aspect also provides a telecommunications apparatus for an end-point of a communications system, the end-point comprising:
a communication interface operable to communicate with a communications system via a low-latency communication link and via a high latency communication link;
an operator interface for providing, to an operator, spatial data defining a model of spatial features;
a command interface for obtaining operator commands from an operator; and,
a controller configured to:
   communicate with the communication system via the high latency communication link to obtain model data defining a model of an environment at a first geographic location;
   communicate with a remote end-point, the remote end-point comprising a data gathering interface for obtaining spatial data defining a first subset of spatial features of the environment at the first geographic location;
   provide, at the operator interface, spatial data defining a model of a second subset of spatial features at the first geographic location;
   provide, via the low latency communication link, a command to the remote end-point to cause the remote end-point to gather real-time data defining a third subset of spatial features;
   wherein the second subset of spatial features comprises the third subset of spatial features and additional data,
   the additional data comprising at least one of the model data and the first subset of spatial features, wherein the second endpoint obtains the additional data via a high latency communications link.

These and other aspects of the disclosure may enable the provision of truly realistic telepresence or tele-existence. Such approaches may require large volumes of 3D visual, audio and haptic data to be transmitted between separate locations on the Earth with very low latency.

Embodiments of the disclosure provide, at a communication end-point, data defining a pseudo real-time 3D model of a remote location. Data used to define that 3D model may be sent from the remote location to the end-point to enable the model to reflect changes in the environment at the remote location in “real time”.

Of course, “real time” in the strict literal sense of that phrase might imply a zero latency link, which is not possible. However, it will be appreciated in the context of the present disclosure that “real-time” may be taken to mean the minimum latency imposed by the communication link between the end-point and the remote location. Embodiments of the present disclosure may therefore aim to reduce this latency. They may do this by using both low-latency communications links, and high-latency communications links, between the end-point and the remote location, and by selecting the data which is transmitted via each link so as to increase the available bandwidth of the low latency-links while reducing the amount of data required per user to be sent via the low-latency communications links.

### BRIEF DESCRIPTION OF DRAWINGS

Embodiments of the disclosure will now be described, by way of example only, with reference to the accompanying drawings in which:

FIG. 1 shows a schematic illustration of a communications system; and

FIG. 2 shows a flow chart illustrating a method of operation of the communications system illustrated in FIG. 1;

In the drawings like reference numerals are used to indicate like elements

### SPECIFIC DESCRIPTION

### Overview of Operation

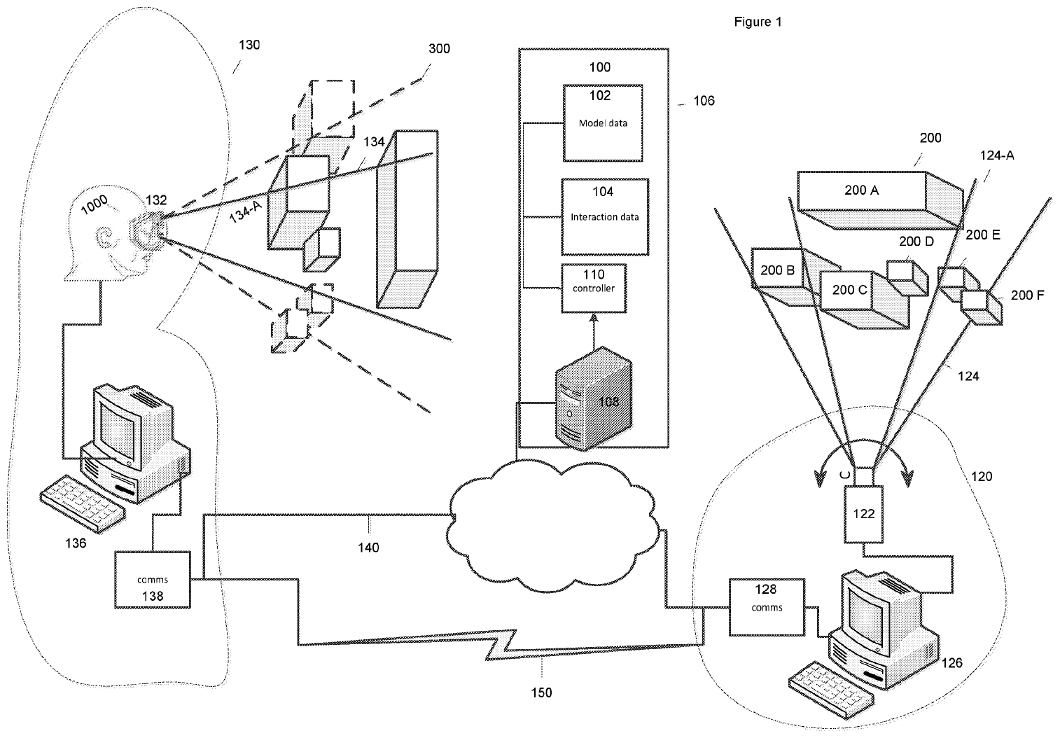

FIG. 1 shows a communications system 100 comprising a communications interface 108, a controller 110, and a data store 106. This may provide a remotely accessible 3D model ‘database’ with rules for supporting communication e.g. to for the provision of telepresence. The communications system 100 is connected to a first end-point 120 and a second end-point 130 by a first communications link 140.

The first endpoint 120 is also coupled to communicate with the second end-point 130 via a second communications link 150 having a lower latency than the first communication link 140. This low latency communication may comprise an optical link between a relay station (which may be carried on an aircraft such as a high altitude platform, HAP) and/or a communication satellite, for example a low earth orbit (LEO) satellite.

The first end-point 120 comprises a controller 126, and a communication interface 128, and a data gathering interface 122 for capturing spatial information about the environment 200 (e.g. structures, movable objects, and landscape) in its vicinity. Temporal information (e.g. time stamps) may also be acquired by the data gathering interface, it will thus be appreciated that the spatial data may also comprise temporal information (e.g. in the form of spatio-temporal data, which may define the times and locations and/or speed and/or acceleration of spatial features in the environment). This spatial information may provide data which can be used to assemble a 3D model of the spatial features 200A-200F of the environment 200 that are within range 124 (e.g. the field of view) of the data gathering interface 122. The communication interface of the first end point may send this spatial information via:
(a) the first communications link 140, for features which are less likely to be interacted with, or to interact with, an operator of the system in a virtual environment to be presented to the operator, such as a human, at the second end point; or
(b) the second communications link 150, for those features which are more likely to be interacted with, or to interact with, the operator in the virtual environment.

As noted above, the spatial data may be augmented with temporal information and may thus comprise spatio-temporal information. In addition, the spatial data may be updated at intervals (e.g. periodically) to reflect changes in the environment such as the movement of objects. The controller 126 at the first end point may be operable to receive requests for this spatial information (e.g. from the second end point 130) and to respond to the requests by sending selected items of the spatial information to the second end point. The controller 126 may determine (e.g. based on the requests) which of the communications links 140, 150, is to be used to send any particular item of spatial information about the environment 200.

The second end-point 130 has an operator interface 132 for providing 3D spatial model data 300 to an operator 1000, this may be provided in the form of a virtual environment, which may comprise a digital representation of selected spatial features of the 3D spatial model. For example, the 3D spatial model may be a dynamic model, updated to reflect changes in the environment at the first end point. And the availability of a low latency link between the two end points, may be used to provide, at the second end-point 130, a real-time 3D spatial model 300 of the environment 200 in the field of view of 124 the first end-point 120. This can be used to provide a “telepresence” experience, and/or to enable control of a robot (not shown in the drawings) at the first end-point 120.

To do this, the second end-point 130 may obtain, via the first communications link 140, a first subset 124 of model data from the data store held by the communications system 100 (e.g. acting as a server). This model data describes a 3D model of the expected spatial environment at the first end-point 120. The first subset of the model data may comprise data in the possible field of view of the data gathering interface 122. Interaction data 104 associated with spatial features 200A-200F in the model of that environment 200 indicates a likelihood that an operator may interact with one or more of those spatial features. This likelihood may comprise a simple indication that a given feature is to be interacted with, and so must be sent. Or an indication that a given feature can, or cannot, be moved or otherwise interacted with.

The operator interface 132 at the second end-point 130 then provides, to the operator 1000, a model of a second subset of the spatial features 134 at the first end-point 120. This second subset of features 134 may correspond to those spatial features in a selected region 124-A of the 3D model 200 of the environment at the first end-point 120 (for example, those features within an interaction range of a virtual location in that 3D model, such as within reach of the view point presented to the human operator).

The controller 110 of the communications system 100 uses the interaction data 104 to identify a third subset of spatial features 134-A which the operator 1000 is able/likely to interact with in the virtual environment at the second end point 130.

The controller 110 then causes the data gathering interface 122 at the first end point 120 to obtain up-to-date (e.g. real time) spatial information describing this third subset of spatial features 134-A as they currently exist in the environment 200 at the first end point. This third subset of the model data is then provided from the first end point 120 to the second end-point 130 via the second (low latency) communication link 150.

### Detail of Some Implementations

The overview of operation set out above is intended to put the discussion which follows into context. There will now be provided an explanation of one implementation of the apparatus shown in FIG. 1 to explain how the above described possibilities may be achieved.

The communications system 100 illustrated in FIG. 1 may be provided by a server which comprises the controller 110, the data store 106, and the communications interface 108 operable to communicate with the first end-point and the second end-point. The data store 106 stores model data 102 defining a 3D digital model of a spatial environment, including the environment 200 in which the first end-point 130 is located.

The controller 110 of the system 100 is configured to communicate with a plurality of end-points and to receive spatial data from any of those end-points, such as the first end point 120, which include a data gathering interface 122. The controller 110 of the system 100 is configured to combine (e.g. to co-register) the spatial data received from different end points to provide a single 3D spatial model incorporating the data received from these different end points. The data store 106 stores digital model data 102 comprising a description of spatial features 200A-200F observed by the first end-points 120. This description may comprise a digital model of the surfaces of objects, such as a point-cloud, wire-frame, or surface model. Other 3D digital models may be used. The controller 110 of the system 100 may also be configured to determine interaction data, corresponding to the spatial features in this 3D digital model. The interaction data may indicate a likelihood that, in a virtual environment presented to an operator, the operator will interact with a given spatial feature in that virtual environment. This may be based on an indication, received from the operator that they wish to interact with a particular feature. It may also be based on indications, received from the second end point, that a given feature is “background”, and so unlikely to be interacted with, or that it is moving and so is likely to be interacted with. This interaction data 104 may be stored in the data store 106 at the system 100 and/or provided at the first end point 120.

The first end-point 120 comprises a controller 126, and a communications interface 128 for communicating via the two communication links 140, 150. It also comprises the data gathering interface 122 mentioned above. Generally, the data gathering interface 122 comprises sensing circuitry operable to provide spatial data defining the surfaces of objects in range of the first end-point 120. This circuitry may comprise optical range finding devices such as lasers, and/or acoustic range finding devices such as ultrasonic devices. Some examples comprise LIDAR, and other systems able to provide 3D data defining surfaces within range of the second end-point.

This first end-point 120 may also be configured to identify stationary objects, landscape, and other “background” features based on one or more of the following:
object recognition image processing techniques, wherein objects of interest, such as people or other interaction targets, are identified as foreground
based on a statistical model of the locations of objects—for example, those objects having a high degree of variance in their position, or which move frequently, may be identified as foreground
the distance from the first end point, so that objects beyond a selected range are identified as background
by identifying foreground features using a dynamically tracked data set corresponding to a volume around the user point of view that they can reach or are directly viewing from moment to moment.

This first end-point 120 may also be configured to identify moving objects in the spatial data it obtains as “non-background”. It may send information identifying these and other non-background objects, and the background objects to the communications system 100 to enable it to determine interaction data 104 about the spatial features in the vicinity of the second end-point (e.g. indicating a likelihood of movement of those features).

Although only one “first” end-point is shown in FIG. 1, a great many of such end-points may be provided, each of which may have a field of view 124 which overlaps with one or more other such end points, and may gather data at different length scales (e.g. with different resolution and relating to differently sized features). 3D sensing systems such as LiDAR or structured light cameras can provide 3D data, by combining 2D imagery with a depth map created via projected structured light over the field of view. Thus 3D data from single points of view can be used. This data may be sent to the communications system 100 to enable the communications system 100 to assemble a dynamic 3D spatial model of the regions covered by the combined fields of view of these end points taken together.

For example, the communications system 100 may co-register this data into a single combined spatial model. To facilitate this, the first end-point may also comprise a location determiner able to provide geographic coordinates of the first end-point. The geographic coordinates may comprise a 3-dimensional position, such as longitude, latitude and altitude. The location determiner may comprise communication and sensing circuitry, for example comprising a sensor, such as an altimeter, for determining altitude, and wireless communicators for determining geographic location. Examples of such communicators include GPS devices, cellular telecommunications devices, and the like. The sensors in this circuitry may also comprise an orientation sensing device such as a magnetometer, gyroscope, or other orientation sensor. Images from the local environment can be compared to previous data sets at that location to achieve a more accurate orientation measurement of the device and user without using built in sensors such as GPS, gyroscopes or accelerometers or other sensors comprising an inertial measurement unit. Other position tracking and orientation measurement approaches may be used—such as those based on image tracking and computer vision techniques.

The first end-point 120 is configured to operate the data gathering interface 122 to obtain spatial data indicating the distance between the data gathering interface 122 and the surfaces of the spatial features 200A-200F in its environment 200. It may also be further configured to operate the location determiner to obtain location data describing the location at which the spatial data was obtained. The spatial data can thus be defined in a known 3D frame of reference (such as by reference to GPS coordinates). The first end-point is further operable to provide this spatial data to the communications system 100 via the first (high latency) communication link, or to the second end-point via the second (low latency) communication link. The first end-point 120 is configured to send data describing stationary objects, landscape, and other background features to the second end point 130 via a high latency link 140. This data may also be sent to the communications system 100 via the first (high latency) communication link 140, from where the second end point 130 may retrieve them, e.g. also via high latency link. The location data enables the spatial features of the environment measured by the data gathering interface 122 to be registered in a 3D spatial model. This registration may be done by the first end-point 120, or it may be done by the device which receives that data, whether the communications system 100 or the second end-point 130. In the case where the communications system 100 performs the registration, this can enable 3D spatial data to be accumulated from a plurality of data gathering devices distributed over a wide geographic area, thereby to accumulate, over time, a general 3D digital model of that wider geographic area. For example, this model might use a mode or mean position for features which move frequently and/or might it allow moving/movable features to be identified so that this can be taken into account in data transmission. In the case of the second end-point this can enable the second end-point 120 to obtain a 3D spatial model of the environment 200 at the first end-point from the communications system 100, and then to update only parts of that model using data relating to specific features requested from the first end-point 120 via the second (low latency) communication link 150. The first end-point 120 is also configured to receive request messages specifying one or more spatial features and to respond to the request messages by sending to the second end-point selected spatial data via the second (low latency) communication link.

The second-end-point 130 also comprises a controller 136, and a communications interface 138 for communicating via the two communication links 140, 150. It also comprises an operator interface 132 for providing spatial data to an operator 1000. For example, the operator interface 132 may comprise a display, such as a stereoscopic display of the type provided in so-called virtual reality headsets and/or augmented reality headsets, but any appropriate 2D or 3D display may be used. The operator interface may also be adapted to provide haptic feedback to the operator, for example it may comprise actuators for applying haptic feedback e.g. mechanical stimulation (such as forces, vibrations, motions, electrical, or thermal stimulus) to the operator. The controller of the second end-point can be configured to control this mechanical stimulation based on the spatial model data provided to the operator. The operator interface may also comprise inputs for obtaining command signals from the operator. The second end-point may be configured to control the spatial model data provided to the operator based on these command signals. For example, these command signals may be used to navigate through the spatial model and/or cause movements of a robot avatar at the first end-point. The second end-point also comprises a data interface for receiving a location request indicating a location in the communications system's 3D model about which the operator wishes to obtain spatial data. The second end-point is operable to respond to such a location request by sending a corresponding request to the communications system 100 to establish a telepresence session at a location indicated by the location request.

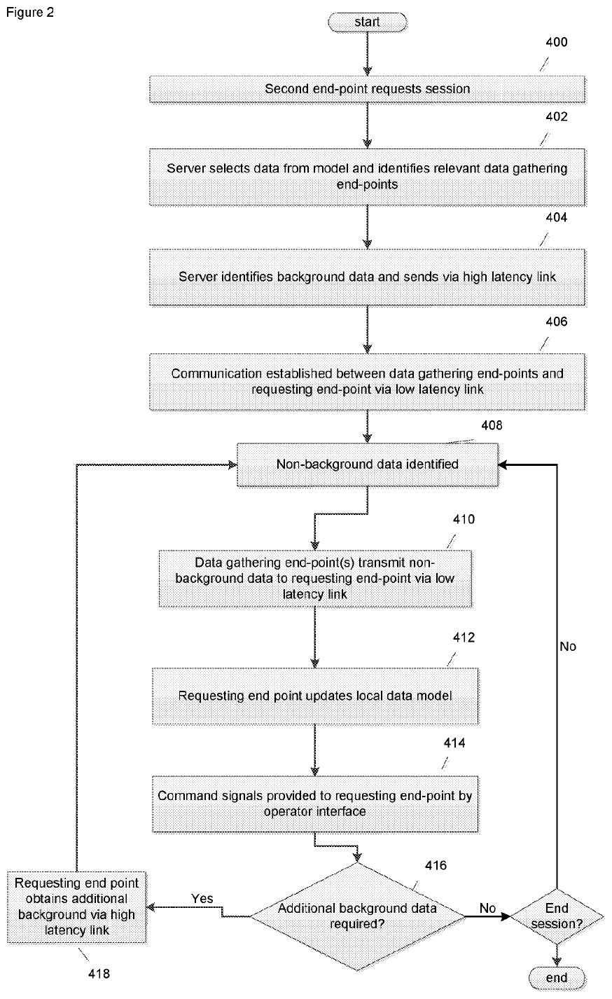

Operation of the system shown in FIG. 1 will now be described with reference to the flow chart shown in FIG. 2.

To establish a telepresence session, a requesting end-point (e.g. the second end-point 130 of FIG. 1) may send 400 a request message to the system 100 e.g. via the high latency communication link. The request message comprises location data indicating the intended geographic location of the telepresence session. This geographic location is typically remote from the second end-point. The request message may also comprise an indication of desired field of view (a region of the data model which the operator requires for the telepresence session).

The communications system 100 uses 402 the location data to identify a data gathering end-point (e.g. the first end-point of FIG. 1) at the remote location. As noted above, the second end-point 130 may obtain, via the first communications link 140, a first subset 124 of model data from the data store held by the communications system 100 (e.g. acting as a server). This first subset 124 of the model data describes a 3D model of the expected spatial environment in the possible field of view of the data gathering interface 122. These may for example correspond to the field of view of the first end-point (e.g. the region from which its data gathering interface is able to gather data). The communications system 100 then also identifies, based on the request message, a second subset of spatial features for example features corresponding to the desired field of view for the telepresence session (e.g. those spatial features present in the region identified in the request message).

The communications system 100 then identifies 404 the “background” parts in this second subset of features of the spatial model, and sends this via the first (high latency) communication link to the second end-point. This can enable the operator interface (such as a VR/AR headset and/or haptic suit) to provide haptic and/or audio visual signals to the operator based on the data model at the requested location.

At this stage 404, the communications system 100 may also send a second request message to the first end-point to cause the first end-point to establish 406 data communication with the second end-point via the second (low latency) communication link. This process, including the downloading of the background data, may take a few tens of seconds, once the background for the initial link is sent the telepresence session can start.

The controller 110 of the communications system 100 uses the interaction data 104 to identify 408 a third subset of spatial features 134-A: namely features that are represented in both the first subset 124-A and the second subset 134, and which the interaction data 104 indicates the operator 1000 is able/likely to interact with. It will thus be appreciated that the first subset may describe the expected spatial environment at the first end-point 120 (e.g. features in the possible field of view and in range of the data gathering interface 122, and the second subset 134 may describe those features which are within interaction range of the view point presented at the second end point 130.

The second request message may comprise interaction data associated with the second subset of features from the data model. This interaction data may identify one or more non-background spatial features, which may cause the first end-point to operate 410 its data gathering interface to obtain spatial information describing these non-background features, which is then sent to the first end point via the low latency link. The second end point can then update its local model of the environment at the first end point. Thus the operator can be provided with near real-time information in the virtual environment provided by the second end point.

The second request message may also cause the first end point periodically to repeat the above operations. The controller 110 can thus cause the data gathering interface 122 at the first end point 120 to continue to obtain up-to-date (e.g. real time) model data describing this third subset of spatial features 134-A as they currently exist in the environment 200 at the first end point. This model data is then provided to the second end-point 130 via the second (low latency) communication link 150. The second end-point 130 can use this model data to augment the stored data obtained from the communications system 100, thereby to provide a more up-to-date, e.g. real time, 3D spatial model of the environment at the first end-point 120, e.g. in a virtual environment presented to the operator 1000 at the second end point 130.

In addition to the above, the operator 1000 may provide 414 command signals at the second end point 130 which cause changes in the virtual environment 134 presented there (such as a shift in view point). This may also cause a request message to be sent to the controller 110 of the system 100 and/or to the first end point. The controller 110 and/or the first end point can then determine 416, based on these command signals, whether additional background data is required. If additional background data is required, it can be obtained as described above and the method 408, 410, 412, 414, 416, 418, may then repeat to maintain a session. This is explained in more detail below.

A variety of methods may be used to provide the interaction data identifying the non-background features. For example:
The operator may pre-select the spatial features they intend to interact with—this may be done when a session is established, or during a session;
The second end-point may predict operator intent based on input signals (such as hand and/or eye movements) and use this to identify the spatial features the operator intends to interact with. In the case of a human operator using an interface such as a VR headset and a wearable haptic feedback device such as a glove, these predictions may be based on gaze direction, body and hand motions, gestures or voice commands.
If the session is established to perform a specific task e.g. using a remote robotic avatar, the spatial features likely to be used in that task may be designated as non-background. The communications system 100 may store a pre-defined list of such tasks and the spatial features likely to be involved, or these may be provided by the requesting endpoint.

However the non-background features are identified, the first end-point operates its data gathering interface to obtain spatial information describing these non-background features and sends this data to the second end-point via the second (low latency) communication link. The data that is sent may comprise difference data only indicating any changes in the non-background features as compared to a preceding transmission relating to those features.

The second end point then uses the data from the first end-point to provide spatial data to the operator via the operator interface. The operator may then provide further command signals to the second end-point via the operator interface—for example these may be a response to the updated spatial data and/or a command to change the location (view point) of the session and/or to change the direction (orientation) of view of the session.

These command signals may be used to determine whether additional background data is required, in which case a request may be communicated to the communications system 100 via the high latency communication link. The communications system 100 may respond by sending data describing the additional background features to the second end-point. This data may be sent pre-emptively (e.g. it may be predicted as described above). Thus, as the point of view required from the remote location changes more background data can be pre-emptively sent via high capacity ground networks thus maintaining a true experience of ‘being there’ while not having to send all data via the low latency free space network.

It will be appreciated in the context of the present disclosure that although the communications system 100 is illustrated in FIG. 1 as a single physical unit, this is merely illustrative. The system 100 may be implemented in a distributed system, for example the data store and/or the controller may be provided by one or more processors and/or data storage systems distributed across a network, for example in a so-called “cloud based” system. As the links may be point-to-point the latency may be primarily (e.g. solely) dependent upon distance between the end-points. Adding servers in-between may relieve pressure on a central processing store dealing with slower updates. These may have delays above ˜150 msec and not affect the quality of experience.

It will be appreciated in the context of the present disclosure that the operator may be a human user, or may be a computer device, for example as part of a robotic control system, or a remote observation and data gathering system. For example, in the case that he operator is a further computer device, the operator interface may be implemented in software—for example according to communications protocol such as UDP.

It will also be appreciated that the data gathering end points may have two modes of operation a passive data gathering mode, and a directed data gathering mode. In the passive data gathering mode, the 3D spatial data is provided to the communications system 100 via the first (high latency) communication link to enable the communications system 100 to establish a global 3D model. In the directed data gathering mode, such as that described above with reference to FIG. 2, the first end-point is configured to respond to a request, received from the second end-point, to provide selected spatial data to the second end-point via the second (low latency) communication link.

The low latency communication link may comprise two stages—a first link-stage between an end-point and a relay station, which may be carried by an aircraft such as a HAP. The relay station may comprise an optical communication interface which provides a second link-stage to a communications satellite such as a low earth orbit (LEO) satellite. The optical communication link may comprise a semiconductor laser which acts as a transmitter, and a receiver comprising a telescope, or similar receiving optics. The optical beam from the transmitter (e.g. on the HAP) is focused on the receiving optics of the receiver at the other end of the communication link. Such a link may be bidirectional, in the sense that both the relay station (e.g. on HAP and in LEO) may carry both transmitter and receiver, but unidirectional links may also be used. The laser beam may be modulated using a scheme such as differential phase shift keying (DPSK) or some other scheme.

The second communication link, RF links and RF communications interfaces described herein may comprise mobile telecommunications functionality, such as that which may be provided by a cellular telephone or mobile broadband interface. It will be appreciated in the context of the present disclosure that this means that the end-points described herein may encompass any user equipment (UE) for communicating over a wide area network and having the necessary data processing capability.

It may comprise a hand-held telephone, a computer equipped with internet access, a tablet computer, a Bluetooth gateway, a specifically designed electronic communications apparatus, or any other device. It will be appreciated that such devices may be configured to determine their own location, for example using global positioning systems GPS devices and/or based on other methods such as using information from WLAN signals and telecommunications signals. Wearable technology devices may also be used. Accordingly, the communication interface of the devices described herein may comprise any wired or wireless communication interface such as WI-FI®, Ethernet, or direct broadband internet connection, and/or a GSM, HSDPA, 3GPP, 4G, EDGE or 5G communication interface. It will thus be appreciated that the wide area network described herein may comprise any appropriate combination of wired and wireless networks such as fibre networks and RF networks.

It is described above that the first endpoint is coupled to communicate with the second end-point via a second communications link having a lower latency than the first communication link. For example, the second communication link may be capable of sending a data message (such as a packet switched message) from the first end-point to the second end-point with a shorter delay between the sending of the packet and its receipt at the other end of the link. This low latency communications link may comprise at least one optical communications link. It will be appreciated in the context of the present disclosure that latency may be protocol dependant. In a TCP/IP based communication, latency may be measured based on the round-trip time of a packet—from source to destination and back. In UDP based communication, latency may be measured based on the one-way trip time of a packet, from source to destination.

Other variations of the system described herein may be used. For example, the interaction data may be determined based on predicting movement of the operator's view point and/or an avatar in the remote environment and identifying potential collisions with spatial features in the environment. Data representing movable objects (for example moving objects) may be identified, and then transmitted via the low-latency links. This may comprise identifying objects in motion, and transmitting the data representing the moving objects via the low-latency links. Data representing static (for example immovable objects) objects may be identified, and then transmitted via the high-latency links such as existing optical fibre networks.

The end points 120, 130 described herein may comprise data gathering interfaces 122 carried on satellites, High Altitude Pseudo Satellites (HAPS) and other types of aircraft such as drones. Ground vehicles, and augmented reality headsets are examples of other devices which may carry data gathering interfaces 122. It will be appreciated in the context of the present disclosure that each of these different types of data gathering end-points may provide data having different resolutions and in different formats. The communications system 100 may be configured to process this data to obtain spatial data describing the physical location of the surfaces of spatial features 200A-200F, and interaction data indicating the possibility for an operator 1000 to interact with a spatial feature in the model.

Where the first end-points are carried on Earth Observation satellites, these may provide wide area coverage and environmental data. The resolution of spatial data provided by such end-points may have a resolution of about 30 cm for structures at sea level, or a coarser resolution such as 1 m or more. They may have a field of view of at least 1 km at sea level, for example at least 10 km, for example 100 km. The data provided from satellite carried end-points may be primarily 2D, but may also comprise weather, pollution, and other environmental data. The update rate of spatial data obtained by the satellite may depend upon its orbit.

The first end-points described herein may also be carried on aircraft such as High Altitude Pseudo Satellites (HAPS). These and other aircraft may carry with high resolution, wide area cameras. Examples of such cameras include may have a 5×5 km FoV at 10 cm GSD in the visible. IR and hyperspectral cameras may also be used. These may be located in the stratosphere, from which altitude the cameras may provide a resolution of structures at sea level of about 10 cm. Such aircraft carried end-points may provide 3D spatial data which forms a base map of the region beneath the HAP and may have a relatively high update rate. These and other types of aircraft may carry 3D survey equipment, such as RADAR, for range finding and 3D mapping of structures on the earth's surface. LIDAR, SONAR, and other 3D mapping techniques may also be used.

The first end-points described herein may also be carried on other types of aircraft, such as cargo and passenger transport aircraft, and observation aircraft—for example helicopters, planes, and delivery drones. Such aircraft may carry LIDAR for range finding and 3D mapping of structures on the earth's surface. They may also carry structured-light 3D scanners, such as a structured light depth camera or other similar device for measuring the three-dimensional shape of an object using projected light patterns, such as stripe/fringe patterns examples of such devices include those employed in Google Project Tango SLAM (Simultaneous localization and mapping) and Microsoft Kinect. In addition, so-called structured light devices, which may use pattern of projected infrared points to generate a dense 3D image for 3D image capture, other devices can be used. One example is a range imaging camera system that employs time-of-flight techniques to resolve distance between the camera and the subject for each point of the image, by measuring the round trip time of an artificial light signal provided by a laser or a LED. LIDAR may also be used. LIDAR and structured light cameras are good at close proximity, and may be used on other devices e.g. such as VR/AR headsets. Other data sources and platforms (such as autonomous cars) may also carry these and other data gathering devices. Such devices may provide resolution of approximately lcm or better depending on range to the object. Close range resolution from sensors on VR/AR headsets could easily be less than 1 mm.

The apparatus described herein, such as the HAPs and endpoints may be used not only for the presentation of real-time data, but also to provide the 3D spatial model itself—e.g. to accumulate the spatial data upon which the model as a whole is based. This enables an interactive digital model of an environment to be established for later use in telepresence. Methods of the disclosure thus comprise providing a low latency communication link between a plurality of end points, the plurality of end points comprising:
(a) a first end-point comprising a data gathering interface for obtaining first spatial data defining spatial features at a first geographic location; and
(b) a second end-point disposed at a second geographic location the second end-point comprising an operator interface adapted to provide interaction with a digital model of the environment at the first geographic location.

The low latency link may comprise a first link-stage between the end points and one or more relay stations, which may be carried on a high altitude pseudo satellite, HAPS, and a second link-stage between the relay station and an interface with a communications network, which may be carried by a satellite. For example, the second link stage may link a relay station carried by a HAPS with one or more LEO satellites.

One or more of the HAPS used for this communication may comprise a data gathering interface, such as those described elsewhere herein for obtaining second spatial data describing spatial features below the HAPS. These and other methods of the disclosure comprise providing the first spatial data and the second spatial data to a controller configured to assemble a 3D digital model based on the first spatial data and the second spatial data; and, providing the 3D digital model to the second end-point; and communicating a request via the low latency communication link from the second end point to the first end point, thereby to update the 3D digital model. The first link-stage comprises an RF link such as a standard RF communications interface. The second link-stage generally comprises an optical link, such as any of the optical links described herein.

The communications described herein, such as those between the end-points herein may comprise packets and/or frames for transmission over a packet switched network. Such messages typically comprise a data payload and an identifier (such as a uniform resource indicator, URI) that identifies the destination and/or source of that message. This may enable the message to be forwarded across a network to the device to which it is addressed. Some messages include a method token which indicates a method to be performed on the resource identified by the request. For example these methods may include the hypertext transfer protocol, HTTP, methods “GET” or “HEAD”. The requests for content may be provided in the form of hypertext transfer protocol, HTTP, requests, for example such as those specified in the Network Working Group Request for Comments: RFC 2616. As will be appreciated in the context of the present disclosure, whilst the HTTP protocol and its methods may be used to implement some features of the disclosure other internet protocols, and modifications of the standard HTTP protocol may also be used.

It will be appreciated in the context of the present disclosure that data transfer between two end points has been described, but data transfer may also take place between a single end-point to multiple users OR from many users to many users (e.g. the case of many people in a ‘reality conference’ with each other in a simulated but common model of a real or virtual space.

The controllers of the end-point devices and/or the controller of the communications system may be implemented with fixed logic such as assemblies of logic gates or programmable logic such as software and/or computer program instructions executed by a processor. Other kinds of programmable logic include programmable processors, programmable digital logic (e.g. a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

It will be appreciated that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. For example the functionality provided by the data store in the communications system 100 may in whole or in part be provided by one or more non-volatile storage systems.

Where controllers have been described it will be appreciated that these controllers provide logic functionality but need not be implemented as a single integrated hardware device. The controllers shown in the drawings are illustrated as a single functional unit, and other functional divisions are also indicated, the functionality need not be divided in this way. The drawings should not however be taken to imply any particular structure of hardware other than that described and claimed herein. The function of one or more of the elements shown in the drawings may be further subdivided, and/or distributed. In some embodiments the function of one or more elements shown in the drawings may be integrated into a single functional unit.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa.

The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in not-transitory form. Hardware includes computers, handheld devices, programmable processors, general purpose processors, application specific integrated circuits, ASICs, field programmable gate arrays, FPGAs, and arrays of logic gates. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

It will be appreciated in the context of the present disclosure that the term high altitude pseudo satellite as used herein may relate to so-called HAPS which are sometimes also called High-altitude platform stations. Examples of such structures are defined in Article 1.66A of the International Telecommunication Unions (ITU) ITU Radio Regulations as “a station on an object at an altitude of 20 to 50 km and at a specified, nominal, fixed point relative to the Earth”. A HAP can be a manned or unmanned and carried on any appropriate aircraft such as an airplane, a balloon, or an airship. The term HAP may encompass “High Altitude Powered Platform”, “High Altitude Aeronautical Platform”, “High Altitude Airship”, “Stratospheric Platform”, “Stratospheric Airship” and “Atmospheric Satellite”. So called “High Altitude Long Endurance” (HALE) platforms associated with conventional unmanned aerial vehicles (UAVs), may also be used. Such platforms may operate at an altitude of at least 12 km, or in some cases at least 12 km.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A communications system comprising:
a data store storing a data model comprising:
(i) model data defining a model of an environment comprising a plurality of spatial features; and
(ii) interaction data indicating a likelihood of interaction of each of the plurality of spatial features;
a communication interface operable to communicate with:
(a) a first end-point comprising a data gathering interface for obtaining spatial data defining a first subset of spatial features at a first geographic location; and
(b) a second end-point disposed at a second geographic location the second end-point comprising an operator interface adapted to provide, via the operator interface, spatial data defining a model of a second subset of spatial features at the first geographic location;
a controller, in communication with the data store and with the end-points, and configured to:
select, from the data model, model data and interaction data corresponding to the second subset of spatial features,
identify, based on the selected model data and the interaction data, a third subset of spatial features represented in the second subset of spatial features and the first subset of spatial features;
operate the first end-point to gather real-time data defining the third subset of spatial features, and to communicate the real-time data to the second end-point via a low-latency communications link;
operate the second end-point to provide, via the operator interface and based on the real-time data and on additional data, spatial data defining the model of the second subset of spatial features,
wherein the additional data comprises at least one of the model data and the first subset of spatial features, wherein the second endpoint obtains the additional data via a high latency communications link.

2. The communications system of claim 1 wherein the interaction data indicates a likelihood of movement of said spatial features.

3. The communications system of claim 1, wherein the controller is configured to identify, in the model data, spatial features adjacent to the second subset of spatial features and to send the identified spatial features to the second end-point via the high latency communications link.

4. The communications system of claim 3, wherein the controller is configured to predict an operation of the second end-point and to identify the spatial features adjacent to the second subset of spatial features based on the predicted operation.

5. The communication system of claim 1, wherein the controller is configured to establish a communication session between the first end-point and the second end-point by sending, to the second end-point, the model data and the interaction data corresponding to the first subset of spatial features.

6. The communication system of claim 5 wherein the model data and the interaction data corresponding to the first subset of spatial features are sent via the high latency communication link.

7. The communications system of claim 1, wherein the low-latency link comprises an aircraft carried radio frequency (RF) telecommunications apparatus for communication with one of the first end-point and the second end-point, and the low latency communication link further comprises an optical communication link between a satellite and the aircraft carried RF telecommunications apparatus.

8. (canceled)

9. A telecommunications apparatus for an end-point of a communications system, the end-point comprising:
a communication interface operable to communicate with a communications system via a low-latency communication link and via a high latency communication link;
an operator interface for providing, to an operator, spatial data defining a model of spatial features;
a command interface for obtaining operator commands from an operator; and,
a controller configured to:
communicate with the communication system via the high latency communication link to obtain model data defining a model of an environment at a first geographic location;
communicate with a remote end-point, the remote end-point comprising a data gathering interface for obtaining spatial data defining a first subset of spatial features of the environment at the first geographic location;
provide, at the operator interface, spatial data defining a model of a second subset of spatial features at the first geographic location;
provide, via the low latency communication link, a command to the remote end-point to cause the remote end-point to gather real-time data defining a third subset of spatial features;
wherein the second subset of spatial features comprises the third subset of spatial features and additional data,
the additional data comprising at least one of the model data and the first subset of spatial features, wherein the second endpoint obtains the additional data via a high latency communications link.

10. The apparatus of claim 9 wherein the interaction data indicates a likelihood of movement of said spatial features.

11. The apparatus of claim 9 or 10, wherein the controller is configured to identify, in the model data, spatial features adjacent to the second subset of spatial features and to obtain the identified adjacent features via the high latency communications link.

12. The apparatus of claim 11, wherein the controller is configured to predict an operation of the operator and to identify the adjacent features based on the predicted operation.

13. The apparatus of any of claim 9 wherein the controller is configured to establish a communication session with the first end-point by requesting the model data and the interaction data corresponding to the first subset of spatial features, wherein the model data and the interaction data corresponding to the first subset of spatial features are obtained via the high latency communication link.

14. (canceled)

15. The apparatus of any of claim 9, wherein the low-latency link comprises a radio frequency (RF) link to a relay station comprising RF telecommunications apparatus.

16. The apparatus of claim 15 wherein the low latency communication link further comprises an optical communication link between a satellite and the relay station.

17. The apparatus of claim 16, wherein the relay station is carried by one of: an aircraft such as a HAP; and a ground based station.

18. A method of providing an interactive digital model of an environment comprising a plurality of spatial features, the method comprising:
providing a low latency communication link between a plurality of end points, the plurality of end points comprising:
(a) a first end-point comprising a data gathering interface for obtaining first spatial data defining spatial features at the first geographic location; and
(b) a second end-point disposed at a second geographic location the second end-point comprising an operator interface adapted to provide interaction with a digital model of the environment at the first geographic location;
wherein the low latency link comprises a first link-stage between an end point and a relay station disposed on a high altitude pseudo satellite, HAPS, and a second link-stage between the relay station and a communications network;
providing the first spatial data to a controller configured to assemble a 3D digital model based on the first spatial data; and,
providing the 3D digital model to the second end-point; and
communicating a request via the low latency communication link from the second end point to the first end point, thereby to update the 3D digital model.

19. The method of claim 18, wherein the first link-stage comprises an RF link, and the second communication link comprises an optical link.

20. The method of claim 18, wherein the communications network comprises at least one low earth orbit (LEO) satellite.

21. The method of claim 18, wherein at least one of:
(a) the first end point; and
(b) the second end point,
is configured to operate a data gathering interface to identify background features, and non-background features in range of the data gathering interface, wherein interaction data is based on this identifying.

22. The method of claim 21 wherein this identifying is based on one or more of the following:
(i) object recognition image processing techniques, wherein objects of interest, such as people or other interaction targets, are identified as foreground;
(ii) based on a statistical model of the locations of objects—for example, those objects having a greater degree of variance in their position than their surroundings or which move frequently, may be identified as foreground;
(iii) the distance from the end point, so that objects beyond a selected range are identified as background;
(iv) identifying foreground features using a dynamically tracked data set corresponding to a volume around the user point of view that they can reach or are directly viewing from moment to moment.
